(19) United States
(12) Patent Application Publication
(10) Pub. No.: US 2016/0063418 A1
(43) Pub. Date: Mar. 3, 2016

(54) System and Method for Inferring Vehicle Health

(71) Applicant: General Electric Company, Schenectady, NY (US)

(72) Inventors: Nicholas Edward Roddy, Schenectady, NY (US); Dustin Ross Garvey, Oakland, CA (US); Rui Xu, Niskayuna, NY (US)

(21) Appl. No.: 14/476,030

(22) Filed: Sep. 3, 2014

(51) Int. Cl. G06Q 10/06

(52) U.S. Cl. CPC G06Q 10/06315

(57) ABSTRACT

A system and method for inferring vehicle health are disclosed. The computer-implemented method comprises identifying a plurality of candidate vehicles for consideration for use for a task, and receiving corresponding event data for at least one of the plurality of candidate vehicles. The event data may correspond to at least one occurrence of at least one suspected problem for the corresponding candidate vehicle. A corresponding health score can be generated for each one of the plurality of candidate vehicles. The corresponding health score for the at least one of the plurality of candidate vehicles can be generated based on the corresponding event data for the at least one of the plurality of candidate vehicles. The generated health scores can indicate a likelihood of failure for their corresponding candidate vehicles.

### TECHNICAL FIELD

The present application relates generally to the technical field of data processing, and, in various embodiments, to a system and method for inferring vehicle health.

### BACKGROUND

Vehicles can be used to perform tasks. For example, locomotives can provide freight and passenger transportation. However, like all machines, vehicles can fail to operate. Operational failure during the performance of a task can severely disrupt the functioning of an organization, increase costs, and even pose a significant danger in some circumstances. Currently, it is difficult to accurately assess and identify which vehicles in a fleet are most likely to experience operational failure during the performance of a task, and which vehicles in a fleet are least likely to experience operation failure during the performance of a task. There is therefore a technical problem in accurately and efficiently assigning healthy vehicles in a fleet to perform tasks, as well as avoiding the assignment of unhealthy vehicles in the fleet to perform tasks.

### BRIEF DESCRIPTION

Some or all of the above needs or problems may be addressed by one or more example embodiments. Example embodiments of a system and method for inferring vehicle health are disclosed.

In one example embodiment, a computer-implemented method comprises identifying a plurality of candidate vehicles for consideration for use for a task, and receiving corresponding event data for at least one of the plurality of candidate vehicles. The event data may correspond to at least one occurrence of at least one suspected problem for the corresponding candidate vehicle. A corresponding health score can be generated for each one of the plurality of candidate vehicles. The corresponding health score for the at least one of the plurality of candidate vehicles can be generated based on the corresponding event data for the at least one of the plurality of candidates. The generated health scores can indicate a likelihood of failure for their corresponding candidate vehicles.

The above and other features, including various novel details of implementation and combination of events, will now be more particularly described with reference to the accompanying figures and pointed out in the claims. It will be understood that the particular techniques, methods, and other features described herein are shown by way of illustration only and not as limitations. As will be understood by those skilled in the art, the principles and features described herein may be employed in various and numerous embodiments without departing from the scope of the present disclosure.

### BRIEF DESCRIPTION OF THE DRAWINGS

Some example embodiments of the present disclosure are illustrated by way of example and not limitation in the figures of the accompanying drawings, in which like reference numbers indicate similar elements, and in which:

FIG. 1 is a network diagram illustrating a client-server system, in accordance with some example embodiments;

FIG. 2 is a block diagram illustrating components of a vehicle health inference system, in accordance with some example embodiments;

FIG. 3 illustrates a table of feature data comprising urgency level case types, in accordance with some example embodiments;

FIG. 4 illustrates a table of log likelihood ratios (LLR's) for feature data comprising urgency level case types, in accordance with some example embodiments;

FIG. 5 illustrates a table of fault data and LLR's, in accordance with some example embodiments;

FIG. 6 illustrates a table of crew reports, in accordance with some embodiments;

FIG. 7 illustrates a table of LLR's for crew reported defect codes, in accordance with some example embodiments;

FIG. 8 is a flowchart illustrating a method, in accordance with some example embodiments, for generating and using health scores for vehicles;

FIG. 9 is a flowchart illustrating a method, in accordance with some example embodiments, for identifying vehicles based on health scores;

FIG. 10 is a flowchart illustrating another method, in accordance with some example embodiments, for generating and using health scores for vehicles;

FIG. 11 is a flowchart illustrating a method, in accordance with some example embodiments, for configuring values to be used in the generation of health scores;

FIG. 12 is a flowchart illustrating a method, in accordance with some example embodiments, for generating health scores for vehicles;

FIG. 13 is a block diagram illustrating a mobile device, in accordance with some example embodiments; and

FIG. 14 is a block diagram of an example computer system on which methodologies described herein can be executed, in accordance with some example embodiments.

The figures are not necessarily drawn to scale and elements of similar structures or functions are generally represented by like reference numerals for illustrative purposes throughout the figures. The figures are only intended to facilitate the description of the various embodiments described herein. The figures do not describe every aspect of the teachings disclosed herein and do not limit the scope of the claims.

### DETAILED DESCRIPTION

Example systems and methods of inferring vehicle health are disclosed. In the following description, for purposes of explanation, numerous specific details are set forth in order to provide a thorough understanding of example embodiments. It will be evident, however, to one skilled in the art that the present embodiments can be practiced without these specific details.

A system and method for inferring vehicle health are disclosed. The computer-implemented method can comprise identifying a plurality of candidate vehicles for consideration for use for a task, and receiving corresponding event data for at least one of the plurality of candidate vehicles. The event data can correspond to at least one occurrence of at least one suspected problem for the corresponding candidate vehicle. A corresponding health score can be generated (e.g., calculated) for each one of the plurality of candidate vehicles. The corresponding health score for the at least one of the plurality of candidate vehicles can be generated based on the corresponding event data for the at least one of the plurality of candidates. The generated health scores can indicate a likelihood of failure for their corresponding candidate vehicles.

Although the techniques disclosed herein are described with reference to vehicles, it is contemplated that the features of the present disclosure can also be applied to other machine-based assets as well, including, but not limited to, factory equipment, construction equipment, and office equipment.

The methods or embodiments disclosed herein may be implemented as a computer system having one or more modules (e.g., hardware modules or software modules). Such modules may be executed by one or more processors of the computer system. In some embodiments, a non-transitory machine-readable storage device can store a set of instructions that, when executed by at least one processor, causes the at least one processor to perform the operations and method steps discussed within the present disclosure.

In the description below, for purposes of explanation only, specific nomenclature is set forth to provide a thorough understanding of the present disclosure. However, it will be apparent to one skilled in the art that these specific details are not required to practice the teachings of the present disclosure.

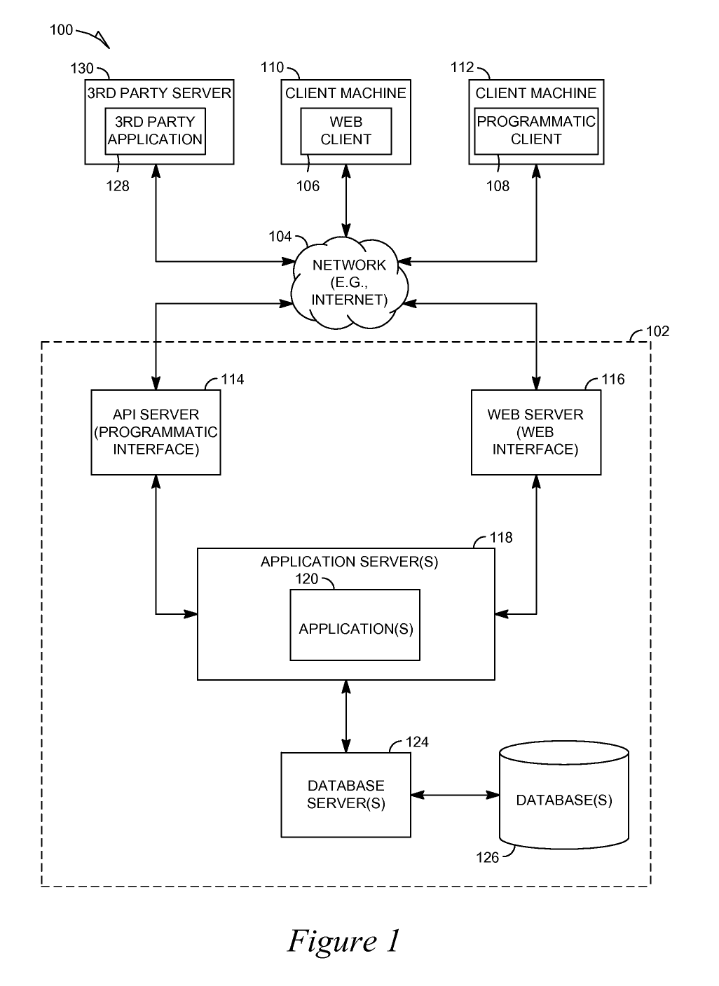

FIG. 1 is a block diagram illustrating a client-server system, in accordance with an example embodiment. A networked system 102 provides server-side functionality via a network 104 (e.g., the Internet or Wide Area Network (WAN)) to one or more clients. FIG. 1 illustrates, for example, a web client 106 (e.g., a browser) and a programmatic client 108 executing on respective client machines 110 and 112.

An Application Program Interface (API) server 114 and a web server 116 are coupled to, and provide programmatic and web interfaces respectively to, one or more application servers 118. The application servers 118 host one or more applications 120. The application servers 118 are, in turn, shown to be coupled to one or more database servers 124 that facilitate access to one or more databases 126. While the applications 120 are shown in FIG. 1 to form part of the networked system 102, it will be appreciated that, in alternative embodiments, the applications 120 may form part of a service that is separate and distinct from the networked system 102.

Further, while the system 100 shown in FIG. 1 employs a client-server architecture, the present disclosure is of course not limited to such an architecture, and could equally well find application in a distributed, or peer-to-peer, architecture system, for example. The various applications 120 could also be implemented as standalone software programs, which do not necessarily have networking capabilities.

The web client 106 accesses the various applications 120 via the web interface supported by the web server 116. Similarly, the programmatic client 108 accesses the various services and functions provided by the applications 120 via the programmatic interface provided by the API server 114.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more functions that are supported by the relevant applications of the networked system 102.

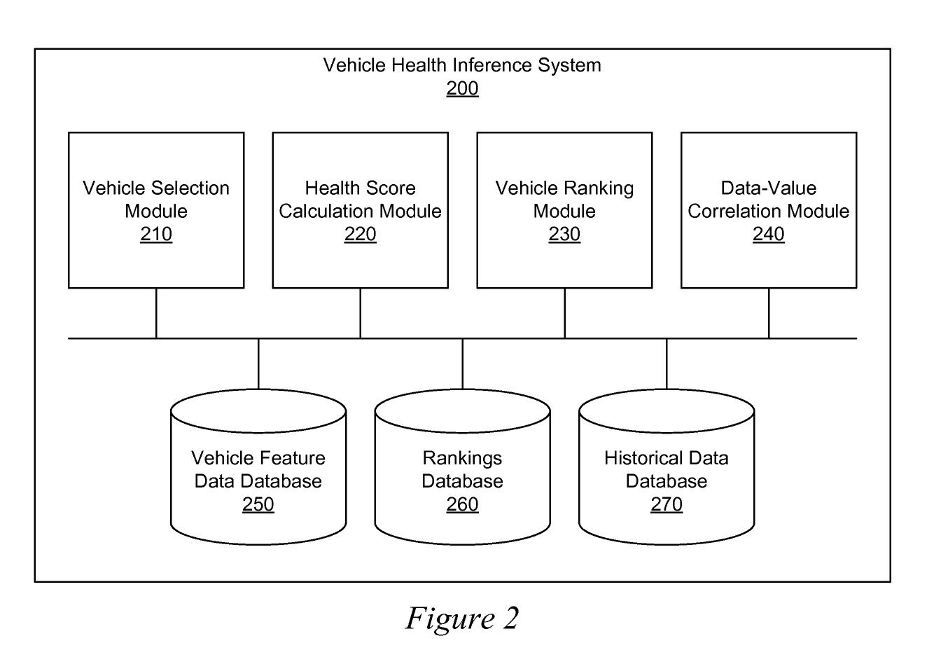

FIG. 2 is a block diagram illustrating components of a vehicle health inference system 200, in accordance with some example embodiments. The vehicle health inference system 200 can comprise any combination of one or more of a vehicle selection module 210, a health score calculation module 220, a vehicle ranking module 230, and a data-value correlation module 240. The vehicle health inference system 200 can also comprise any combination of one or more of a vehicle feature data database 250, a rankings database 260, and a historical data database 270.

These modules 210, 220, 230, 240 and databases 250, 260, 270 may be communicatively coupled to each other. The modules 210, 220, 230, 240 and databases 250, 260, 270 can reside on a machine having a memory and at least one processor (not shown). These components of the health inference system 200 can also reside on separate machines. In some example embodiments, modules 210, 220, 230, and 240 can be incorporated into the application server(s) 118 in FIG. 1 and databases 250, 260, 270 can be incorporated into the database(s) 126 in FIG. 1. However, other configurations are also within the scope of the present disclosure.

The vehicle selection module 210 can be configured to identify a plurality of candidate vehicles for consideration for use in the performance of a task. The vehicle selection module 210 can select the plurality of candidate vehicles from a fleet of vehicles that are determined to be available for use in the task. For example, a list of vehicles for an organization, along with a corresponding indication of each vehicle's availability (e.g., available for use, unavailable due to current use, unavailable due to problem) can be stored in the vehicle feature data database 250. The vehicle selection module 210 can be configured to select a predetermined number of candidate vehicles based on one or more criteria. For example, when selecting candidate vehicles, the vehicle selection module 210 can give preference to vehicles that have the longest amount of time since they have last been used (e.g., a vehicle that was last used three months ago can be selected over a vehicle that was last used one month ago). Other criteria for selecting the candidate vehicles can be used as well.

The candidate vehicles can comprise any vehicles suitable for the performance of a task, including, but not limited to, locomotives, trucks, cars, other types of automobiles, construction vehicles (e.g., bulldozers, forklifts), airplanes, helicopters, and other types of aircraft. As previously mentioned, it is contemplated that the operations of the present disclosure can also be applied to machine-based assets other than vehicles, including, but not limited to, factory equipment, construction equipment, and office equipment.

The health score calculation module 220 can be configured to receive corresponding feature data for each one of the candidate vehicles, which can be stored in the vehicle feature data database 250 in association with the corresponding vehicle. The feature data can comprise any factors that can influence the health (e.g., the likelihood of operational failure) of a vehicle. It is contemplated that the vehicle feature data database 250 can obtain the feature data in a variety of ways, including, but not limited to, transmission of the feature data from an onboard system of the corresponding vehicle to the vehicle health inference system 200, as well as manual entry of the feature data into the vehicle feature data database 250 by a user via a user interface of the vehicle health inference system 200. Other techniques for obtaining the feature data are also within the scope of the present disclosure.

In some example embodiments, the feature data can comprise event data. The event data may comprise data corresponding to at least one occurrence of at least one suspected problem for the corresponding candidate vehicle. The event data may comprise any combination of one or more of an identification of a suspected problem, an indication of a severity level of a suspected problem, a quantity of occurrences of a suspected problem, a status of a suspected problem, and an indication of at least one remedy that has been applied to resolve a suspected problem. The event data can be part of any combination of one or more of case activity data, fault data, and crew report data. The event data will be discussed in further detail below.

In some example embodiments, the feature data can additionally or alternatively comprise characteristic data of the corresponding candidate vehicle. The characteristic data can comprise any data, other than the event data, that can be used to characterize a vehicle. Examples of characteristic data include, but are not limited to, an age of the corresponding candidate vehicle (e.g., number of years since manufactured) and a measurement of usage of the corresponding candidate vehicle (e.g., number of megawatt hours (mwhrs)).

The health score calculation module 220 can be configured to generate a corresponding health score for each one of the plurality of candidate vehicles, and then store the generated health score in the rankings database 260 in association with the corresponding candidate vehicle. The generated health scores can indicate a likelihood of failure for their corresponding candidate vehicles. In some example embodiments, the corresponding health scores for the candidate vehicles can be generated based on corresponding feature data of the candidate vehicles. Although, it is contemplated that some of the candidate vehicles may not have corresponding feature data, and can alternatively be assigned a default health score, can have their health score generated based on other factors, or can be removed from consideration for use in the task for which the candidate vehicles are being considered. In some example embodiments, the corresponding health scores for the candidate vehicles can be generated based on the corresponding event data for the candidate vehicles. Although, it is contemplated that some of the candidate vehicles may not have corresponding event data, and can alternatively have their health scores generated based on other factors. In some example embodiments, the corresponding health scores for the candidate vehicles can be generated based on characteristic data of the corresponding candidate vehicle. Although, it is contemplated that some of the candidate vehicles may not have corresponding characteristic data, and can alternatively have their health scores generated based on other factors. Additionally, the corresponding health scores for the candidate vehicles can be generated based on both corresponding event data and corresponding characteristic data.

In some example embodiments, generating the corresponding health score for a candidate vehicle may comprise retrieving a corresponding value for corresponding feature data of the candidate vehicle. Corresponding values for different feature data can be stored and retrieved from a historical data database 270. The historical data database 270 may comprise correlations between feature data and corresponding values. The health score calculation module 220 can generate the corresponding health score for a candidate vehicle based on the retrieved value for the feature data corresponding to the candidate vehicle, as will be discussed in further detail below.

In some example embodiments, each corresponding value for the feature data comprises a corresponding log likelihood ratio (LLR) of a probability that the corresponding feature data (e.g., specific event data) is present in vehicles that have had an operational failure within a specified time period (e.g., within the last 3 days) to a probability that the corresponding feature data is present in vehicles that have not had an operation failure within the specified time period. However, it is contemplated that the use of other values in generating the health scores is also within the scope of the present disclosure.

The data-value correlation module 240 can be configured to generate, or otherwise determine, the corresponding values for the feature data, and to store the correlation between the feature data and their corresponding values. In some example embodiments, the data-value correlation module 240 can receive historical data for reference vehicles. The reference vehicles can comprise the same vehicles or same type of vehicles as the candidate vehicles. It is contemplated that the historical data database 270 can obtain the historical data in a variety of ways, including, but not limited to, transmission of the historical data from an onboard system of the corresponding vehicle to the vehicle health inference system 200, as well as manual entry of the historical data into the historical data database 270 by a user via a user interface of the vehicle health inference system 200. Other techniques for obtaining the historical data are also within the scope of the present disclosure.

The historical data may comprise historical event data and failure data. The historical event data may correspond to at least one occurrence of a suspected problem for the corresponding reference vehicle, and may comprise the same type of data as the event data previously discussed. The failure data may indicate whether or not the corresponding reference vehicle had an operational failure associated with the occurrence of the suspected problem (e.g., whether or not the reference vehicle has an operational failure concurrently with the occurrence of the suspected problem).

The data-value correlation module 240 can determine the corresponding value (e.g., LLR) for the corresponding event data in the vehicle feature data database 250 based on an analysis of the historical data. The analysis of the historical data may comprise a determination of one or more correlations between the corresponding historical event data and the corresponding failure data. The determined values can then be stored in the vehicle feature data database 250 in association with their corresponding feature data for later use in generation of the health scores for the candidate vehicles.

The vehicle ranking module 230 can be configured to generate a ranked list of the candidate vehicles based on their corresponding health scores. For example, the vehicle ranking module 230 can rank the candidate vehicles from top to bottom in ascending order of health scores or in descending order of health scores. The vehicle ranking module 230 can store the ranked list in the rankings database 260 for subsequent use in selecting candidate vehicles for use for a task.

The vehicle selection module 210 can be configured to select or identify a portion (e.g., one or more) of the candidate vehicles based on the corresponding health scores of the candidate vehicles. In some example embodiments, the vehicle selection module 210 can identify a topmost portion or a bottommost portion of the candidate vehicles of a ranked list (e.g., the 10 healthiest vehicles based on health scores, the 10 least healthy vehicles based on health scores). In some other example embodiments, the vehicle selection module 210 can identify a portion of the candidate vehicles based on the corresponding health scores for the candidate vehicles of the identified portion satisfying a predetermined threshold (e.g., the identified candidate vehicles having health scores above a predetermined value, the identified candidate vehicles having health scores below a predetermined value). It is contemplated that the vehicle selection module 210 can select or identify candidate vehicles based on other health score criteria as well.

The vehicle selection module 210 can also be configured to assign the identified portion of candidate vehicles to be used for a task. Assigning the identified portion of candidate vehicles to be used for a task can include, but is not limited to, transmitting a notification of the identified candidate vehicles to a user on a computing device (e.g., desktop computer, laptop computer, mobile device), causing a notification of the identified candidate vehicles to be displayed to a user on a computing device, and interfacing with a scheduling application to automatically schedule the identified candidate vehicles for use in a task.

The functions and features of the vehicle health inference system 200 will now be discussed in more detail below. One way in which the vehicle health inference system 200 can operate is as follows. For any vehicle at any particular time, the vehicle health inference system 200 can collect all of the feature data that provides meaningful information about the health of the vehicle. The vehicle health inference system 200 can convert all of that information into a single health score. The system 200 can then generate a ranking of all of the vehicles in a fleet with respect to their health at any given time. The system 200 can also segment the fleet into at least two categories: one category with a high risk of failure, and the other category without a high risk of failure. This ranking and segmentation can be used to ensure that the healthiest locomotives are selected for high priority tasks.

In some example embodiments, this scoring, ranking, and segmentation process is performed for vehicles that are determined to have a working communication connection to the vehicle health inference system 200. If there is a communication problem, the vehicle can be assigned an undefined health score (e.g., a not-a-number (NaN) value) in order to avoid making an inference about the vehicle's health in case relevant information is missing or unavailable. In some example embodiments, if no feature data is available for a vehicle, then a score of zero can be returned or assigned to the vehicle. Healthy vehicles can have a health score of zero, and unhealthy vehicles can have a non-zero value for their health scores, with larger numbers implying lower health. Other configurations and meanings of health scores are also within the scope of the present disclosure.

In some example embodiments, the vehicle health inference system 200 is configured to generate (e.g., calculate) a health score for a specific vehicle at a particular point in time. The system 200 can retrieve all of the feature data of interest from the different available databases. For example, the system 200 can retrieve case (e.g., problem) activity data and fault data from one or more remote monitoring and diagnostics (RM&D) databases. The system 200 can also retrieve crew report history data from a user's database. After loading the feature data, the system 200 has useful information for determining a health score.

After the vehicle health inference system 200 obtains the feature data, it can incrementally step through a list of feature types and increment a health score for the vehicle based on what is present for the vehicle under consideration. The system 200 can begin by selecting a feature type and collecting all of the instances of the selected feature type in the data collected for the vehicle. Next, the system 200 can look up a previously calculated value, such as an LLR, for each of the available features of the specified type. The LLR can be a measure of the relative likelihood that a feature will be present when there is a failure in a specified time period (e.g., the next three days) versus when there is not a failure. Larger LLRs can imply that the feature is more likely to be present before failures.

After the vehicle heath inference system 200 has the LLR's for all of the available features of the current feature type, it can then take the maximum of the available LLR's. It has been discovered by the inventors of the present application that when it comes to placing the vehicle in a high risk category, the maximum LLR for a feature type carried the instructive information. In other words, the system 200 was just as accurate in classifying failure risk with the most severe feature as it was with using an aggregation of LLR's. Using the maximum LLR can result in less computational expense than using an aggregation. However, it is contemplated that the use of an aggregation of LLR's is also within the scope of the present disclosure.

The vehicle health inference system 200 can increment the health score by the maximum LLR for the feature. Then, the system 200 can return to the beginning, where it selects the next feature type, and then repeats the above operation until it has examined each feature type. Once the system 200 has examined each feature type, it can return the resulting health score. Again, a health score of zero can be interpreted as healthy, and progressively larger positive scores can be interpreted as increasingly unhealthy. However, other configurations and interpretations are also within the scope of the present disclosure.

As previously discussed, the vehicle health inference system 200 can check for communication problems with the vehicle being evaluated in order to ensure that it does not make an inference about the health of the vehicle if it might be missing relevant information. The result of this check enables the system 200 to return a “don't know” category to ensure that a user or an application has all of the relevant information to make the correct decision in selecting a vehicle for a task.

The communication check can begin with the set of feature data collected for an individual vehicle at a particular point in time. The vehicle health inference system 200 can extract case activity data from the set of feature data. The system 200 can then determine if the extracted case activity data indicates any cases of urgency B that are still open for the vehicle. Urgency B cases indicate communication problems. It is contemplated that the phrase “urgency B” is used herein as a label, and that other labels can be used to refer to the same type and level of communication problems. If the system 200 does not detect any open cases of type urgency B, it can infer that there is not a communication problem with the vehicle.

On the other hand, if the system 200 detects an open case of type urgency B, the system 200 can perform additional operations to verify that the problem is still relevant. The system 200 can determine the delivery time of the most recent open urgency B case and extract all of the fault data from the feature data. The system 200 can determine whether the vehicle has any faults that were created since the delivery of the communication related case. If there have been faults that were created in the database, then it can be determined by the system 200 that communication was reestablished with the vehicle, and the system 200 can infer that there are no current communication problems with the vehicle. If there have not been any faults created, then the system 200 can determine that communication has not been reestablished with the vehicle.

A variety of different types of feature data can be used by the vehicle health inference system 200. As part of an explanation of some of the different types of feature data, a ranked list of the LLR's that quantify the impact that each feature's presence can have on the health score of a vehicle will be presented.

One type of feature data is case activity data. Cases, in the form of case activity data, can be created when a user reports a problem or when a specific pattern is present in incoming data (e.g., data transmitted to the system from a vehicle). Each created case can have a troubleshooting process associated with it. Each case can have a numeric identification (ID) that defines what type of problem may be present with the vehicle. Each ID can also give an urgency level that quantifies the significance of an occurrence of the case. Examples of different urgencies can include, but are not limited to:
a) B (blue): roughly interpreted as a possible communication problem;
b) W (white): low priority problem that doesn't fundamentally affect a locomotive's operational capability;
c) Y (yellow): moderate priority problem that may affect a locomotive's ability; and
d) R (red): high priority problem that is likely to result in a serious problem and should be addressed immediately.

In addition to having information that describes the type of problem, several pieces of information can be recorded that describe what happened as a result of a case being created. For example, case activity data can include the following results of a case:
a) Feedback=Save: reported problem was discovered and corrected; and
b) Feedback=Miss: reported problem was not discovered and could have been caused by:
   i) Miss Code=4A: problem was discovered and corrected that was outside the scope of the delivered troubleshooting process;
   ii) Miss Code=4B: no trouble found (NTF);
   iii) Miss Code=4C: case was deleted before worked; or
   iv) Miss Code=4F: case was deferred by field operations.

The vehicle health inference system 200 can retrieve all of the cases that were delivered for the vehicle in the most recent time period (e.g., within the last 30 days). From these cases, the system 200 can create feature data that characterizes the unaddressed (e.g., “open”) and addressed problems (e.g., “closed”). For the closed cases, the system 200 can create feature data that denotes that the suggested problem was found and addressed (e.g., “saves”) and features that denote that the suggested problem was not found (e.g., “misses”). The system 200 can consider all types of misses, but can exclude from consideration 4C since it indicates that a prescription or remedy was not delivered.

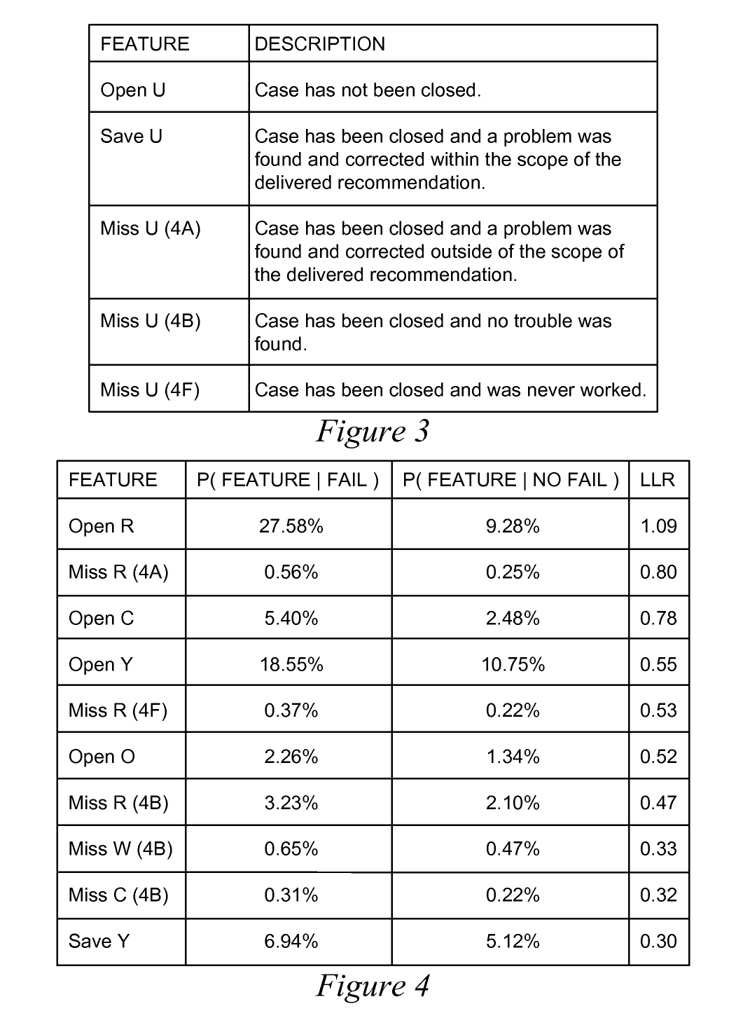

FIG. 3 illustrates a table of feature data comprising urgency level case types, in accordance with some example embodiments. Here, “U” refers to the urgency of the problem and can be R, Y, or W, as mentioned above.

FIG. 4 illustrates a table of LLR's for feature data comprising urgency level case types, in accordance with some example embodiments. The feature data that has no occurrences in samples with or without a failure can be removed. The feature data that is more likely to occur in samples where there is no failure in a specified time period (e.g., within the next three days) can also be removed.

In some embodiments, the most impacting feature data can be open cases, followed by case types that are associated with NTF's or problems not being addressed, and finally a grouping of saves. In other words, active problems can be most instructive, possible unaddressed problems can be a bit less instructive, and a record of addressed defects can be the least instructive, which can be reflected by the corresponding LLR's. However, there can be unexpected LLR's for certain feature data, such as Miss R (4A) in FIG. 4.

Fault data can also be used. In some example embodiments, fault data that has occurred within a specified period of time (e.g., faults that occur within 7 days of the time of interest) can be distinguished from other fault data and used by the vehicle health inference system 200 in generating a health score for a vehicle. The system 200 can also distinguish between active and inactive faults. To infer if a fault is active, the system 200 can do two things. For historical data, the system 200 can determine if the reset time is later than the test time. For live data, the system 200 can determine if the reset time has been set. Similar to the cases previously discussed, the system 200 can avoid considering faults that do not occur in any of the samples or are less likely to occur before a failure.

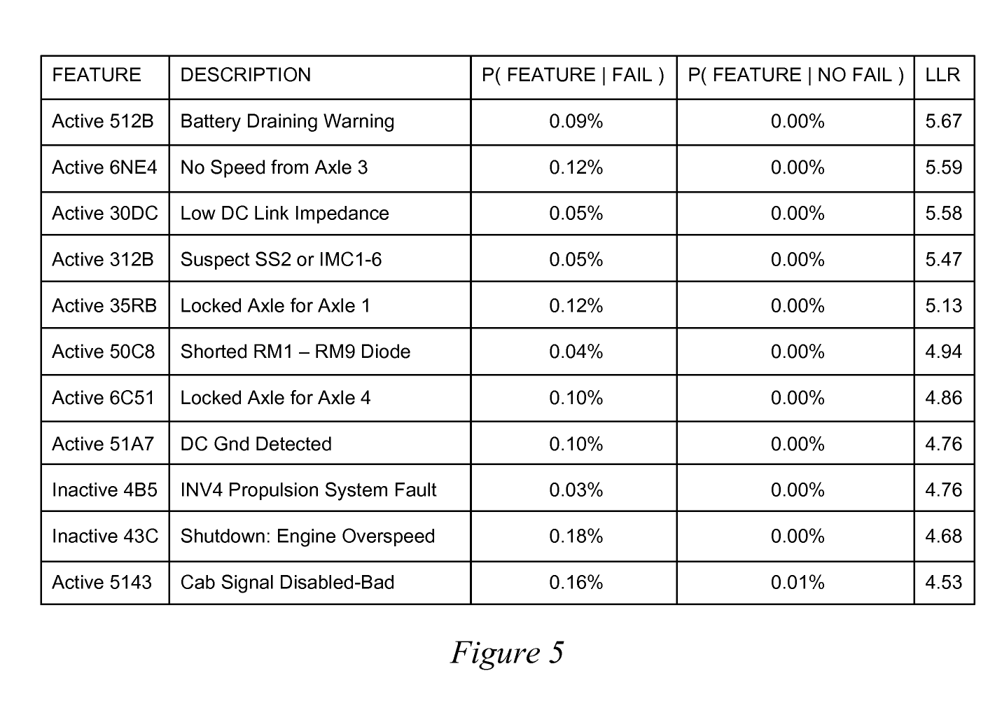

FIG. 5 illustrates a table of fault data and LLR's, in accordance with some example embodiments. As can be seen, the active faults can be the majority of the most important faults.

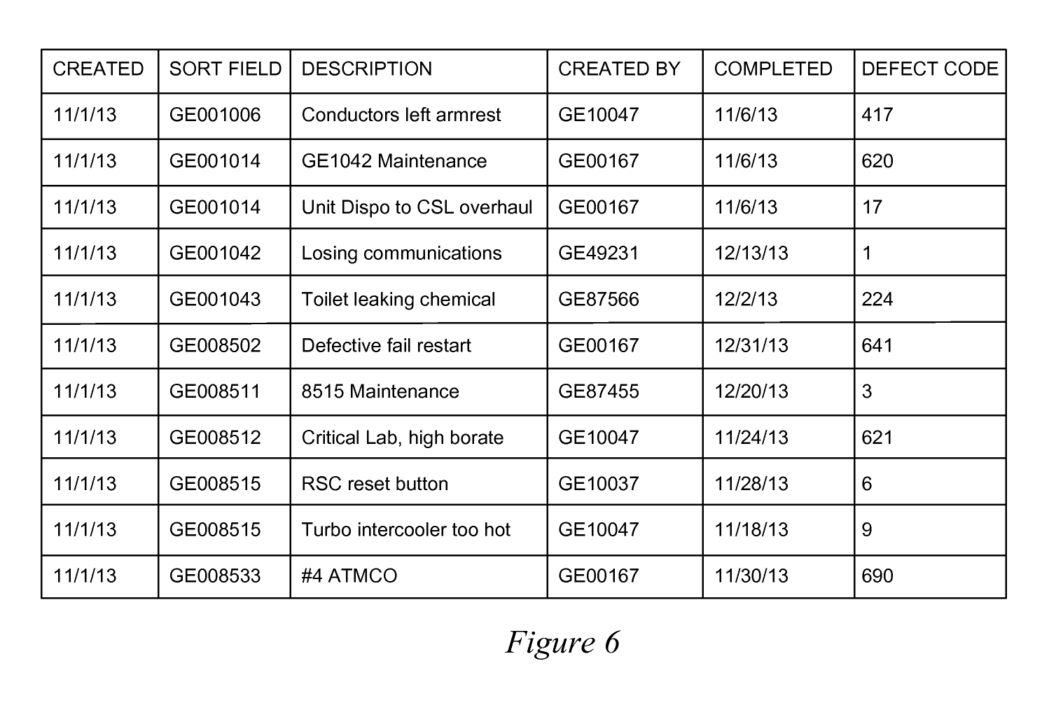

Another type of feature data that can be used is crew report data, which can be retrieved from a set of reports that are generated by one or more users of the vehicle (e.g., the crew of a locomotive). FIG. 6 illustrates a table of crew reports, in accordance with some embodiments. The table of FIG. 6 includes a list of specific problems that are reported for individual locomotives (road number is last 4 digits of the Sort Field). In addition to the free text description of the problem, the defects can be codified. Each defect code can be treated as feature data, and corresponding LLRs that quantify the impact of the problems can be determined. The vehicle health inference system 200 can restrict its consideration of defect codes to defect codes that have been created within a specified time period (e.g., within seven days of the test time).

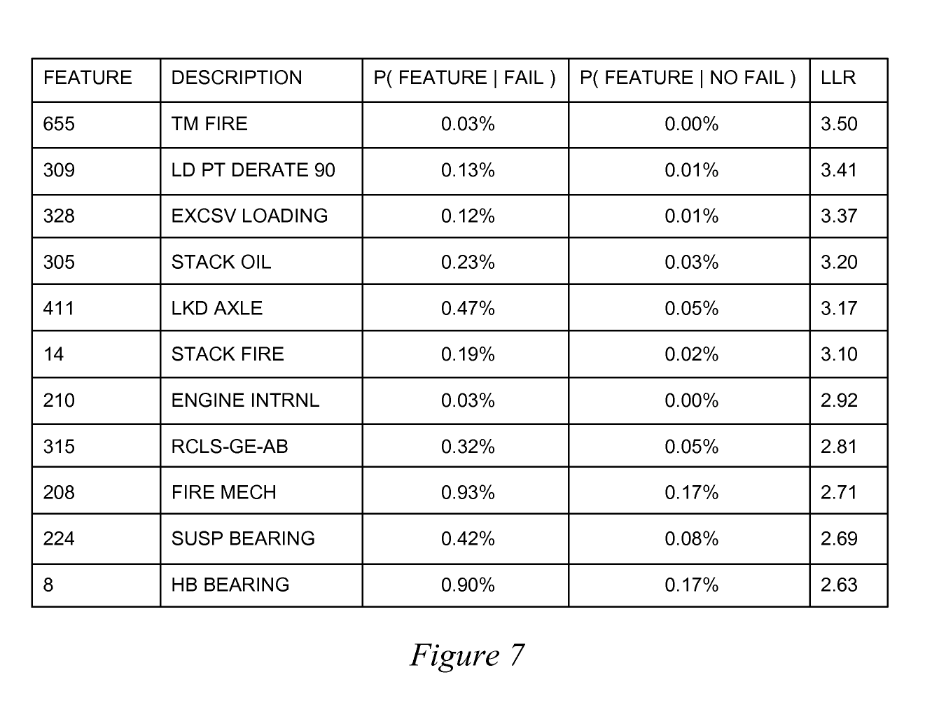

FIG. 7 illustrates a table of LLR's for crew reported defect codes, in accordance with some embodiments. As with the faults, there are many different types of defect codes, so only a sample of the defect codes are presented in FIG. 7. This data source can provide observability into symptoms that are not observable from an incoming stream of case history data and fault data. Additionally, the most impactful feature data useful for inferring likelihood of failure in an upcoming task can be tightly coupled with immediate symptoms.

The method by which the vehicle health inference system 200 calculates the LLR's can be broken into two parts. In the first part, the system 200 can generate all of the feature data that is present for vehicles that do and do not fail within a specified time period (e.g., within the next three days). In the second part, the system 200 can use the different sets to calculate the LLR of the probability that a feature is present in vehicles with and without failures. The term feature can mean different types of case activity, faults, defect codes, and other feature data.

The vehicle health inference system 200 can randomly sample a vehicle and a point in time from historical data. The system 200 can also examine failure information to determine whether or not the vehicle had a failure within a specified time period. The system 200 can then load all of the features that are associated with the sample and place them in the appropriate set given the value of a failure flag. The system 200 can repeat this process until it has a large number of samples (e.g., 20,000 samples). The result of this sampling are two collections of features that can be used to determine if individual features are more likely to be present in vehicles with and without immediate failures.

The vehicle health inference system 200 can then calculate a score impacting metric, such as an LLR, for each of the features. The system 200 can select a feature from the set of all features available for consideration. Next, the system 200 can calculate the probabilities of observing that feature in vehicles with and without failure. If count(Feature|Fail) is the total number of features in the failure samples and count(Feature=f|Fail) is the total number of the selected feature in the failure samples, the probability of observing the feature in locomotives that have a failure in the next three days can be calculated as follows:

$$P ( Feature = f \vert Fail ) = \frac{count ( Feature = f \vert Fail )}{count ( Feature \vert Fail )}$$

Similarly, to get the probability of occurrence of a feature given no failure, the system 200 can evaluate:

$$P ( Feature = f \vert NoFail ) = \frac{count ( Feature = f \vert NoFail )}{count ( Feature \vert NoFail )}$$

These probabilities can then be used by the system 200 to calculate the LLR via:

$$llr ( Feature = f ) = ln ( \frac{P ( Feature = f \vert Fail )}{P ( Feature = f \vert NoFail )} )$$

The system 200 can store the feature and its LLR for later use. This process can then be repeated until the system 200 has examined each of the considered features.

At this point, the vehicle health inference system 200 has the set of features and their associated LLR's. The system 200 can filter these to meet specific requirements. In some example embodiments, the system 200 can only filter instances where the LLR cannot be calculated (e.g., no occurrences of the feature in one of the samples) or when the LLR is less than or equal to zero. The system 200 can get an LLR of less than or equal to zero when the feature is at least if not more likely to be present in vehicles that do not have a failure in the immediate future. An LLR of less than or equal to zero can imply that:

P(Feature=f|Fail)≦P(Feature=f|NoFail)

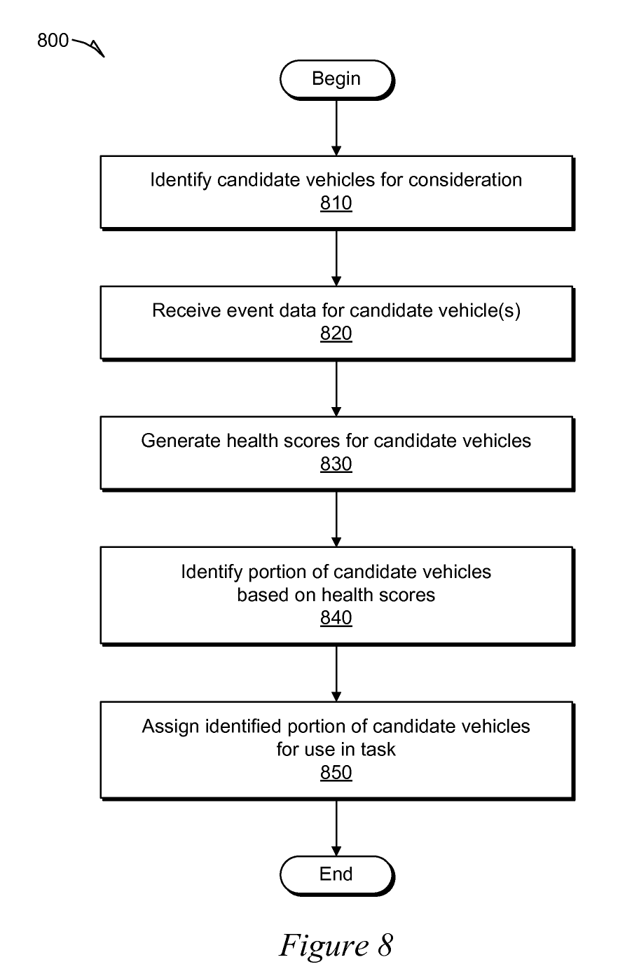

FIG. 8 is a flowchart illustrating a method 800, in accordance with some example embodiments, for generating and using health scores for vehicles. Method 800 can be performed by processing logic that can comprise hardware (e.g., circuitry, dedicated logic, programmable logic, microcode, etc.), software (e.g., instructions run on a processing device), or a combination thereof. In one implementation, the method 800 is performed by the vehicle health inference system 200 of FIG. 2, or any combination of one or more of its modules, as described above.

At operation 810, a plurality of candidate vehicles can be identified for consideration for use for a task. At operation 820, corresponding event data for at least one of the plurality of candidate vehicles can be received. The event data can correspond to at least one occurrence of at least one suspected problem for the corresponding candidate vehicle. At operation 830, a corresponding health score can be generated for each one of the plurality of candidate vehicles. The corresponding health score for the candidate vehicle having event data can be generated based on the event data. The generated health scores can indicate a likelihood of failure for their corresponding candidate vehicles. At operation 840, a portion of the plurality of candidate vehicles can be identified based on the corresponding health scores for the candidate vehicles. At operation 850, the identified portion of the plurality of candidate vehicles can be assigned to be used for the task. It is contemplated that any of the other features described within the present disclosure can be incorporated into method 800.

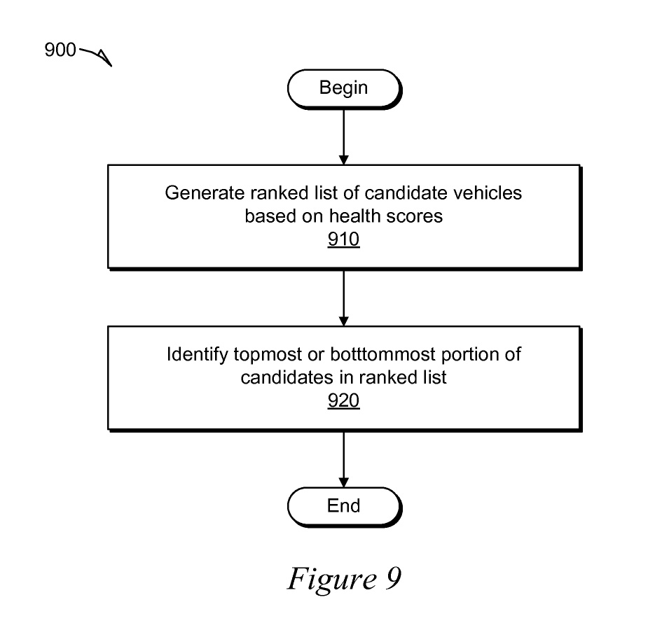

FIG. 9 is a flowchart illustrating a method 900, in accordance with some example embodiments, for identifying vehicles based on health scores. Method 900 can be performed by processing logic that can comprise hardware (e.g., circuitry, dedicated logic, programmable logic, microcode, etc.), software (e.g., instructions run on a processing device), or a combination thereof. In one implementation, the method 900 is performed by the vehicle health inference system 200 of FIG. 2, or any combination of one or more of its modules, as described above.

At operation 910, a ranked list of a plurality of candidate vehicles can be generated based on the corresponding health scores of the candidate vehicles. At operation 920, a topmost portion or a bottommost portion of the plurality of candidate vehicles in the ranked list can be identified. It is contemplated that any of the other features described within the present disclosure can be incorporated into method 900.

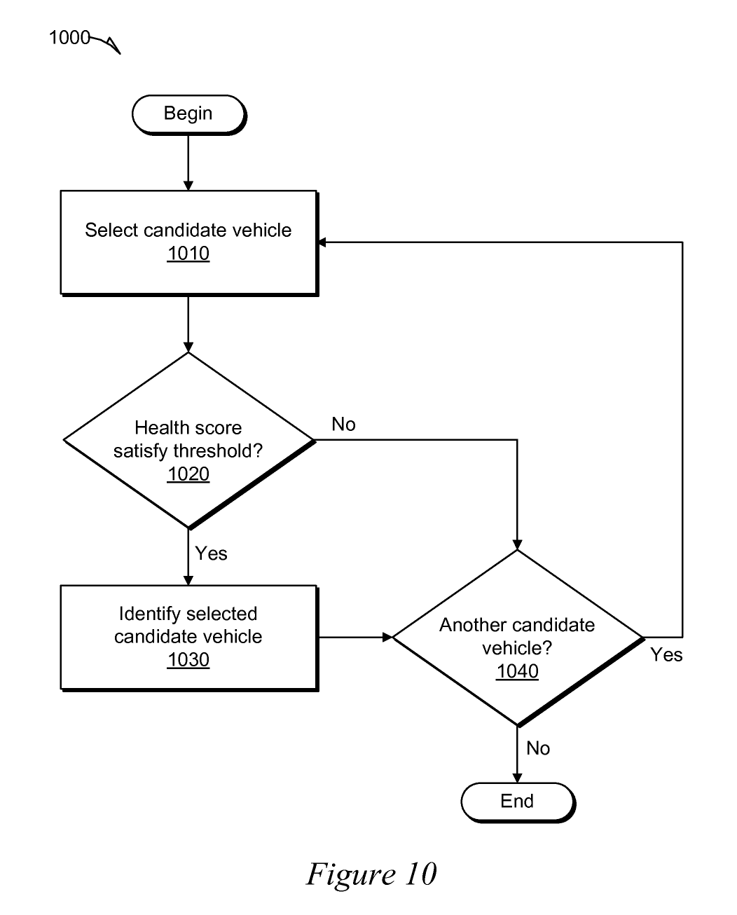

FIG. 10 is a flowchart illustrating another method 1000, in accordance with some example embodiments, for generating and using health scores for vehicles. Method 1000 can be performed by processing logic that can comprise hardware (e.g., circuitry, dedicated logic, programmable logic, microcode, etc.), software (e.g., instructions run on a processing device), or a combination thereof. In one implementation, the method 1000 is performed by the vehicle health inference system 200 of FIG. 2, or any combination of one or more of its modules, as described above.

At operation 1010, a candidate vehicle from a plurality of candidate vehicles can be selected. At operation 1020, it can be determined whether or not the corresponding health score of the selected candidate vehicle satisfies a predetermined threshold. Based on a determination that the corresponding health score does satisfy the predetermined threshold, the selected candidate vehicle can be identified as satisfying the predetermined threshold, at operation 1030. It can then be determined, at operation 1040, whether or not there are any other candidate vehicles to evaluate in terms of their health score. If it is determined that there are not any other candidate vehicles to consider, then the method 1000 can terminate. If it is determined that there is another candidate vehicle to evaluate, then the method 1000 returns to operation 1010, where another candidate vehicle is selected at operation. If it is determined, at operation 1020, that the corresponding health score of the selected candidate vehicle does not satisfy the predetermined threshold, then the method 1000 can proceed to operation 1040, where it is determined whether or not there are any other candidate vehicles to evaluate in terms of their health score. It is contemplated that any of the other features described within the present disclosure can be incorporated into method 1000.

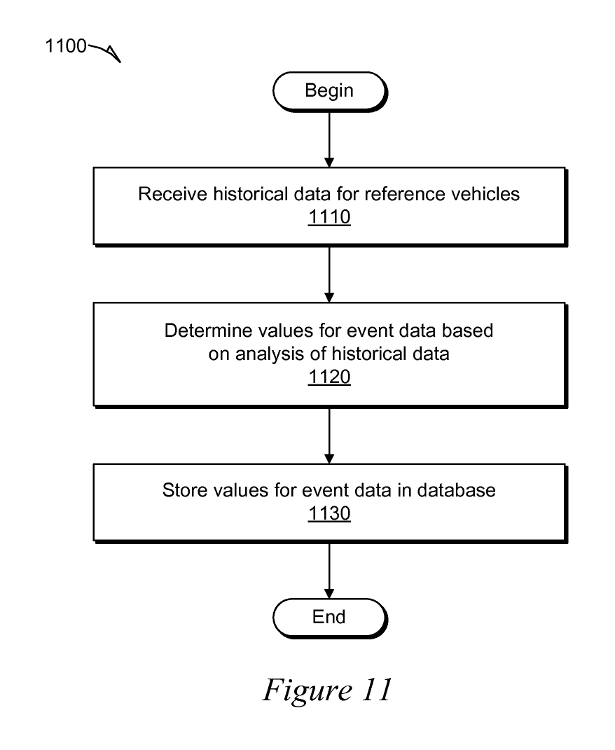

FIG. 11 is a flowchart illustrating a method 1100, in accordance with some example embodiments, for configuring values to be used in the generation of health scores. Method 1100 can be performed by processing logic that can comprise hardware (e.g., circuitry, dedicated logic, programmable logic, microcode, etc.), software (e.g., instructions run on a processing device), or a combination thereof. In one implementation, the method 1100 is performed by the vehicle health inference system 200 of FIG. 2, or any combination of one or more of its modules, as described above.

At operation 1110, corresponding historical data for each one of a plurality of reference vehicles can be received. The historical data can comprise historical event data and failure data. The historical event data can correspond to at least one occurrence of the at least one suspected problem for the corresponding reference vehicle, and the failure data can indicate whether or not the corresponding reference vehicle had an operational failure. At operation 1120, corresponding values (e.g., LLR's) for event data can be determined based on an analysis of the historical data. At operation 1130, the corresponding values for the corresponding event data can be stored in a database. It is contemplated that any of the other features described within the present disclosure can be incorporated into method 1100.

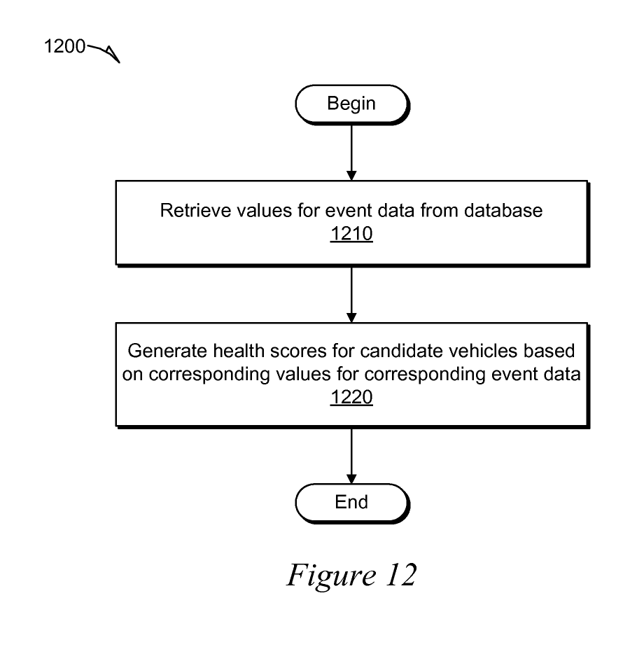

FIG. 12 is a flowchart illustrating a method 1200, in accordance with some example embodiments, for generating health scores for vehicles. Method 1200 can be performed by processing logic that can comprise hardware (e.g., circuitry, dedicated logic, programmable logic, microcode, etc.), software (e.g., instructions run on a processing device), or a combination thereof. In one implementation, the method 1200 is performed by the vehicle health inference system 200 of FIG. 2, or any combination of one or more of its modules, as described above.

At operation 1210, a corresponding value for the corresponding event data for each one of the at least one of the plurality of candidates can be retrieved from a database. The database can comprise correlations between the corresponding event data and the corresponding values. At operation 1220, corresponding health scores for a plurality of candidate vehicles can be generated based on the corresponding values of the event data of the candidate vehicles. It is contemplated that any of the other features described within the present disclosure can be incorporated into method 1200.

### Example Mobile Device

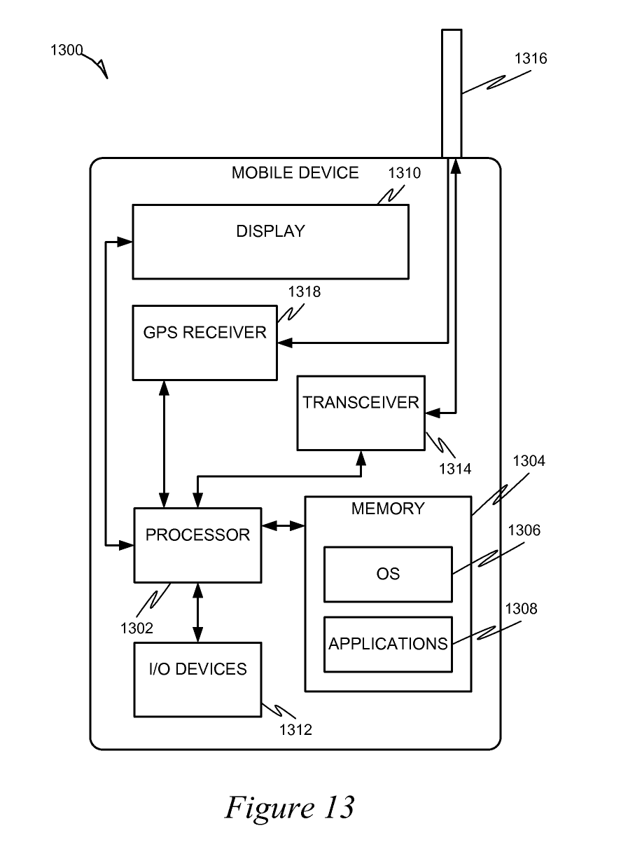

FIG. 13 is a block diagram illustrating a mobile device 1300, according to an example embodiment. The mobile device 1300 can include a processor 1302. The processor 1302 can be any of a variety of different types of commercially available processors suitable for mobile devices 1300 (for example, an XScale architecture microprocessor, a Microprocessor without Interlocked Pipeline Stages (MIPS) architecture processor, or another type of processor). A memory 1304, such as a random access memory (RAM), a Flash memory, or other type of memory, is typically accessible to the processor 1302. The memory 1304 can be adapted to store an operating system (OS) 1306, as well as application programs 1308, such as a mobile location enabled application that can provide LBSs to a user. The processor 1302 can be coupled, either directly or via appropriate intermediary hardware, to a display 1310 and to one or more input/output (I/O) devices 1312, such as a keypad, a touch panel sensor, a microphone, and the like. Similarly, in some embodiments, the processor 1302 can be coupled to a transceiver 1314 that interfaces with an antenna 1316. The transceiver 1314 can be configured to both transmit and receive cellular network signals, wireless data signals, or other types of signals via the antenna 1316, depending on the nature of the mobile device 1300. Further, in some configurations, a GPS receiver 1318 can also make use of the antenna 1316 to receive GPS signals.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the network 104 of FIG. 1) and via one or more appropriate interfaces (e.g., APIs).

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

A computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

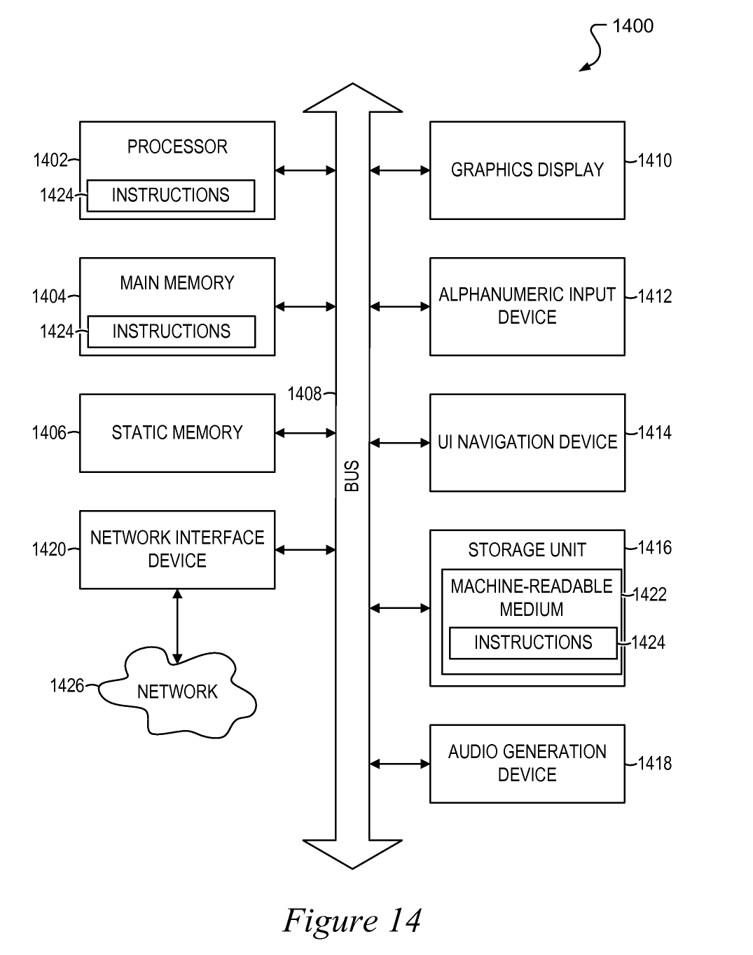

FIG. 14 is a block diagram of a machine in the example form of a computer system 1400 within which instructions for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1400 includes a processor 1402 (e.g., a central processing unit (CPU), a graphics processing unit (GPU) or both), a main memory 1404 and a static memory 1406, which communicate with each other via a bus 1408. The computer system 1400 may further include a graphics or video display unit 1410 (e.g., a liquid crystal display (LCD) or a cathode ray tube (CRT)). The computer system 1400 also includes an alphanumeric input device 1412 (e.g., a keyboard), a user interface (UI) navigation (or cursor control) device 1414 (e.g., a mouse), a storage unit (e.g., a disk drive unit) 1416, an audio or signal generation device 1418 (e.g., a speaker), and a network interface device 1420.

### Machine-Readable Medium

The storage unit 1416 includes a machine-readable medium 1422 on which is stored one or more sets of data structures and instructions 1424 (e.g., software) embodying or utilized by any one or more of the methodologies or functions described herein. The instructions 1424 may also reside, completely or at least partially, within the main memory 1404 and/or within the processor 1402 during execution thereof by the computer system 1400, the main memory 1404 and the processor 1402 also constituting machine-readable media. The instructions 1424 may also reside, completely or at least partially, within the static memory 1406.

While the machine-readable medium 1422 is shown in an example embodiment to be a single medium, the term “machine-readable medium” may include a single medium or multiple media (e.g., a centralized or distributed database, and/or associated caches and servers) that store the one or more instructions 1424 or data structures. The term “machine-readable medium” shall also be taken to include any tangible medium that is capable of storing, encoding or carrying instructions for execution by the machine and that cause the machine to perform any one or more of the methodologies of the present embodiments, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and compact disc-read-only memory (CD-ROM) and digital versatile disc (or digital video disc) read-only memory (DVD-ROM) disks.

### Transmission Medium

The instructions 1424 may further be transmitted or received over a communications network 1426 using a transmission medium. The instructions 1424 may be transmitted using the network interface device 1420 and any one of a number of well-known transfer protocols (e.g., HTTP). Examples of communication networks include a LAN, a WAN, the Internet, mobile telephone networks, POTS networks, and wireless data networks (e.g., WiFi and WiMax networks). The term “transmission medium” shall be taken to include any intangible medium capable of storing, encoding, or carrying instructions for execution by the machine, and includes digital or analog communications signals or other intangible media to facilitate communication of such software.

Each of the features and teachings disclosed herein can be utilized separately or in conjunction with other features and teachings to provide a system and method for inferring vehicle health. Representative examples utilizing many of these additional features and teachings, both separately and in combination, are described in further detail with reference to the attached figures. This detailed description is merely intended to teach a person of skill in the art further details for practicing preferred aspects of the present teachings and is not intended to limit the scope of the claims. Therefore, combinations of features disclosed above in the detailed description may not be necessary to practice the teachings in the broadest sense, and are instead taught merely to describe particularly representative examples of the present teachings.

Some portions of the detailed descriptions herein are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the below discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may include a general purpose computer selectively activated or reconfigured by a computer program stored in the computer. Such a computer program may be stored in a computer readable storage medium, such as, but is not limited to, any type of disk, including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The methods or algorithms presented herein are not inherently related to any particular computer or other apparatus. Various general purpose systems, computer servers, or personal computers may be used with programs in accordance with the teachings herein, or it may prove convenient to construct a more specialized apparatus to perform the required method steps. A structure for a variety of these systems will appear from the description below. It will be appreciated that a variety of programming languages may be used to implement the teachings of the disclosure as described herein.

Moreover, the various features of the representative examples and the dependent claims may be combined in ways that are not specifically and explicitly enumerated in order to provide additional useful embodiments of the present teachings. It is also expressly noted that all value ranges or indications of groups of entities disclose every possible intermediate value or intermediate entity for the purpose of original disclosure, as well as for the purpose of restricting the claimed subject matter. It is also expressly noted that the dimensions and the shapes of the components shown in the figures are designed to help to understand how the present teachings are practiced, but not intended to limit the dimensions and the shapes shown in the examples.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A computer-implemented method comprising:
identifying a plurality of candidate vehicles for consideration for use for a task;
receiving corresponding event data for at least one of the plurality of candidate vehicles, the event data corresponding to at least one occurrence of at least one suspected problem for the corresponding candidate vehicle; and
generating, by a machine having a memory and at least one processor, a corresponding health score for each one of the plurality of candidate vehicles, the corresponding health score for the at least one of the plurality of candidate vehicles being generated based on the corresponding event data for the at least one of the plurality of candidate vehicles, the generated health scores indicating a likelihood of failure for their corresponding candidate vehicles.

2. The computer-implemented method of claim 1, wherein the event data comprises an identification of the at least one suspected problem.

3. The computer-implemented method of claim 1, wherein the event data comprises an indication of a severity level of the at least one suspected problem.

4. The computer-implemented method of claim 1, wherein the event data comprises a quantity of occurrences of the at least one suspected problem.

5. The computer-implemented method of claim 1, wherein the event data comprises a status of the at least one suspected problem.

6. The computer-implemented method of claim 1, wherein the event data comprises an indication of at least one remedy that has been applied to resolve the at least one suspected problem.

7. The computer-implemented method of claim 1, wherein the corresponding health score for at least a portion of the plurality of candidate vehicles is generated based on at least one characteristic of the corresponding candidate vehicle.

8. The computer-implemented method of claim 7, wherein the at least one characteristic comprises an age of the corresponding candidate vehicle or a measurement of usage of the corresponding candidate vehicle.

9. The computer-implemented method of claim 1, wherein generating the corresponding health score for the at least one of the plurality of candidate vehicles comprises:
retrieving, from a database, a corresponding value for the corresponding event data for each one of the at least one of the plurality of candidates, the database comprising correlations between the corresponding event data and the corresponding values; and
generating the corresponding health score for the at least one of the plurality of candidate vehicles based on the corresponding value.

10. The computer-implemented method of claim 9, wherein the corresponding value comprises a corresponding log likelihood ratio (LLR) of a probability that the corresponding event data is present in vehicles that have had an operational failure within a specified time period to a probability that the corresponding event data is present in vehicles that have not had an operation failure within the specified time period.

11. The computer-implemented method of claim 10, further comprising:
receiving corresponding historical data for each one of a plurality of reference vehicles, the historical data comprising historical event data and failure data, the historical event data corresponding to at least one occurrence of the at least one suspected problem for the corresponding reference vehicle, and the failure data indicating whether or not the corresponding reference vehicle had an operational failure;
determining the corresponding LLR for the corresponding event data based on an analysis of the historical data; and
storing the corresponding LLR for the corresponding event data in the database.

12. The computer-implemented method of claim 11, wherein the analysis of the historical data comprises a determination of one or more correlations between the corresponding historical event data and the corresponding failure data.

13. The computer-implemented method of claim 1, further comprising:
generating a ranked list of the plurality of candidate vehicles based on their corresponding health scores; and
identifying a topmost portion or a bottommost portion of the plurality of candidate vehicles in the ranked list.

14. The computer-implemented method of claim 13, further comprising assigning the identified portion of the plurality of candidate vehicles to be used for the task.

15. The computer-implemented method of claim 1, further comprising identifying a portion of the plurality of candidate vehicles based on the corresponding health scores for the candidate vehicles of the identified portion satisfying a predetermined threshold.

16. The computer-implemented method of claim 15, further comprising assigning the identified portion of the plurality of candidate vehicles to be used for the task.

17. The computer-implemented method of claim 1, wherein the plurality of candidate vehicles comprises a plurality of locomotives.

18. A system comprising:
a machine having at least one module, the at least one module comprising at least one processor and being configured to perform operations comprising:
identifying a plurality of candidate vehicles for consideration for use for a task;
receiving corresponding event data for at least one of the plurality of candidate vehicles, the event data corresponding to at least one occurrence of at least one suspected problem for the corresponding candidate vehicle;
calculating a corresponding health score for each one of the plurality of candidate vehicles, the corresponding health score for the at least one of the plurality of candidate vehicles being generated based on the corresponding event data for the at least one of the plurality of candidate vehicles, the generated health scores indicating a likelihood of failure for their corresponding candidate vehicles; and
identifying a portion of the plurality of candidate vehicles based on their corresponding health scores.

19. The system of claim 18, wherein the event data comprises at least one of an identification of the at least one suspected problem, an indication of a severity level of the at least one suspected problem, a quantity of occurrences of the at least one suspected problem, a status of the at least one suspected problem, and an indication of at least one remedy that has been applied to resolve the at least one suspected problem.

20. A non-transitory machine-readable storage medium, tangibly embodying a set of instructions that, when executed by at least one processor, causes the at least one processor to perform operations comprising:
identifying a plurality of candidate vehicles for consideration for use for a task;
receiving corresponding event data for at least one of the plurality of candidate vehicles, the event data corresponding to at least one occurrence of at least one suspected problem for the corresponding candidate vehicle;
generating a corresponding health score for each one of the plurality of candidate vehicles, the corresponding health score for the at least one of the plurality of candidate vehicles being generated based on the corresponding event data for the at least one of the plurality of candidate vehicles, the generated health scores indicating a likelihood of failure for their corresponding candidate vehicles; and
generating a ranked list of the plurality of candidate vehicles based on their corresponding health scores.
